(19) United States
(12) Patent Application Publication
(10) Pub. No.: US 2021/0351439 A1
(43) Pub. Date: Nov. 11, 2021

(54) BATTERY AND METHOD FOR MANUFACTURING BATTERY

(71) Applicant: Panasonic Intellectual Property Management Co., Ltd., Osaka (JP)

(72) Inventors: KOICHI SAWADA, Hyogo (JP); SHUJI ITO, Nara (JP); MASAHISA FUJIMOTO, Osaka (JP); YU OTSUKA, Osaka (JP); MITSUHIRO HIBINO, Kyoto (JP)

(21) Appl. No.: 17/381,128

(22) Filed: Jul. 20, 2021

Related U.S. Application Data
(63) Continuation of application No. PCT/JP2019/051324, filed on Dec. 26, 2019.

(30) Foreign Application Priority Data
May 22, 2019 (JP) 2019-096320

(51) Int. Cl. H01M 10/0569; H01M 4/587; H01M 10/0525; H01M 10/0568; H01M 10/058; H01M 4/40

(52) U.S. Cl. CPC H01M 10/0569; H01M 4/587; H01M 10/0525; H01M 2004/027; H01M 10/058; H01M 4/405; H01M 10/0568

(57) ABSTRACT

The present disclosure provides a new battery capable of having an increased capacity per weight. A battery according to the present disclosure includes a positive electrode, a negative electrode, and an electrolyte located between the positive electrode and the negative electrode. The positive electrode includes a positive electrode layer containing graphene oxide. The electrolyte includes a Lewis acid containing a pentafluorophenyl group.

### BACKGROUND

### 1. Technical Field

The present disclosure relates to a battery and a method for manufacturing a battery.

### 2. Description of the Related Art

Lithium ion secondary batteries have a high energy density, However, since a transition metal compound having a high specific gravity is contained, in general, there is a limit to capacity per weight (hereafter referred to as “capacity”). Batteries having a higher capacity are required for application to next-generation mobility.

U.S. Pat. No. 9,070,932 discloses a secondary battery in which a nanostructure carbon material such as graphene oxide or oxidized carbon nanotube is used for a positive electrode active material.

### SUMMARY

One non-limiting and exemplary embodiment provides a new battery capable of having a high capacity.

In one general aspect, the techniques disclosed here feature a battery including a positive electrode, a negative electrode, and an electrolyte located between the positive electrode and the negative electrode, wherein the positive electrode includes a positive electrode layer containing graphene oxide, and the electrolyte includes a Lewis acid containing a pentafluorophenyl group.

According to the present disclosure, a new battery capable of having a high capacity can be provided.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a schematic sectional view illustrating a configuration example of a battery according to an embodiment;

FIG. 2 is a schematic sectional view illustrating a modified example of a battery according to an embodiment; and

FIG. 3 is a graph illustrating discharge characteristics of a secondary battery produced in an example.

### DETAILED DESCRIPTION

### Underlying Knowledge Forming Basis of the Present Disclosure

In the secondary battery according to U.S. Pat. No. 9,070,932, a carbon material is used for a positive electrode material, and weight reduction and a corresponding increase in capacity are expected. However, according to research by the present inventors, the increase in capacity attained in such a secondary battery is still insufficient. The present inventors found that a further increase in capacity was attained by a battery in which a positive electrode including a positive electrode layer containing graphene oxide was included and in which an electrolyte including a Lewis acid containing a pentafluorophenyl group was included.

### Outline of Aspect According to Present Disclosure

A battery according to an aspect of the present disclosure includes a positive electrode including a positive electrode layer containing graphene oxide, a negative electrode, and an electrolyte that is located between the positive electrode and the negative electrode and that includes a Lewis acid containing a pentafluorophenyl group. The graphene oxide can function as an active material of carrier ions such as lithium ions and sodium ions. It is conjectured that oxygen of the graphene contributes to the above-described function. A Lewis acid containing a pentafluorophenyl group can have the property of providing oxygen that is involved in a charge-discharge reaction to the graphene oxide, An electrolyte containing the Lewis acid can dissolve a large amount of oxygen. Therefore, the battery can attain a further increased capacity.

According to a second aspect, for example, the weight ratio of oxygen to carbon (hereafter referred to as “O/C ratio”) in the graphene oxide may be greater than or equal to 0.1 and less than or equal to 0.3. When the graphene oxide has an O/C ratio in this range, a further increased capacity is more reliably attained.

According to a third aspect, for example, the Lewis acid may be tetrakis(pentafluorophenyl)borate. Tetrakis(pentafluorophenyl)borate can have a strong property of providing oxygen to the graphene oxide.

According to a fourth aspect, for example, the concentration of the Lewis acid in the electrolyte may be greater than or equal to 6% by weight.

According to a fifth aspect, for example, the concentration of the Lewis acid in the electrolyte may be greater than or equal to 16% by weight. The concentration of the Lewis acid in the electrolyte being in each of the above-described ranges enables the concentration of oxygen dissolved in the electrolyte to increase.

According to a sixth aspect, for example, the negative electrode may include a negative electrode layer capable of occluding and releasing lithium ions. According to this aspect, a lithium ion secondary battery can be constructed.

According to a seventh aspect, for example, the negative electrode layer may include an active material containing a lithium element.

According to an eighth aspect, for example, the negative electrode layer may contain lithium metal as an active material.

According to a ninth aspect, the electrolyte may be an electrolyte solution containing a nonaqueous solvent and a lithium salt dissolved in the nonaqueous solvent.

According to a tenth aspect, the nonaqueous solvent may be a carbonic acid ester. The carbonic acid ester can have high voltage-resistance characteristics for a solvent of an electrolyte solution.

According to an eleventh aspect, for example, the lithium salt may be lithium tetrafluoroborate (LiBF₄). An electrolyte solution containing LiBF₄ can have high lithium ion conductivity.

According to a twelfth aspect, for example, the battery according to each of the above-described aspects may be produced by using a method for manufacturing a battery that includes dissolving oxygen in an electrolyte including a Lewis acid containing a pentafluorophenyl group and that includes charging a precursor battery including a positive electrode, a negative electrode, and the electrolyte in which oxygen is dissolved, the electrolyte being located between the positive electrode and the negative electrode, and wherein the positive electrode in the precursor battery includes a precursor layer containing a carbon material and the electrolyte. According to this method, the carbon material is oxidized by the charging of a precursor battery so as to form graphene oxide. Consequently, the precursor layer becomes the positive electrode layer containing graphene oxide.

According to a thirteenth aspect, for example, in the charging of a precursor battery, the precursor battery may be charged while the potential of the positive electrode relative to a Li/Li⁺ reference electrode is set to be greater than or equal to 4.3 V.

### Embodiment

The embodiment of the battery according to the present disclosure will be described below. In this regard, each of the following explanations illustrates a comprehensive or specific example. Numerical values, compositions, shapes, film thicknesses, electrical characteristics, battery structures, electrode materials, and the like described below are exemplifications and are not intended to limit the present disclosure. The constituents that are not described in the independent claim illustrating the most significant concept are optional constituents.

Of the following descriptions, a material represented by a substance name is not limited to being a stoichiometric composition and also includes nonstoichiometric compositions, unless otherwise specified.

### 1. Battery

### 1-1. Overall Configuration

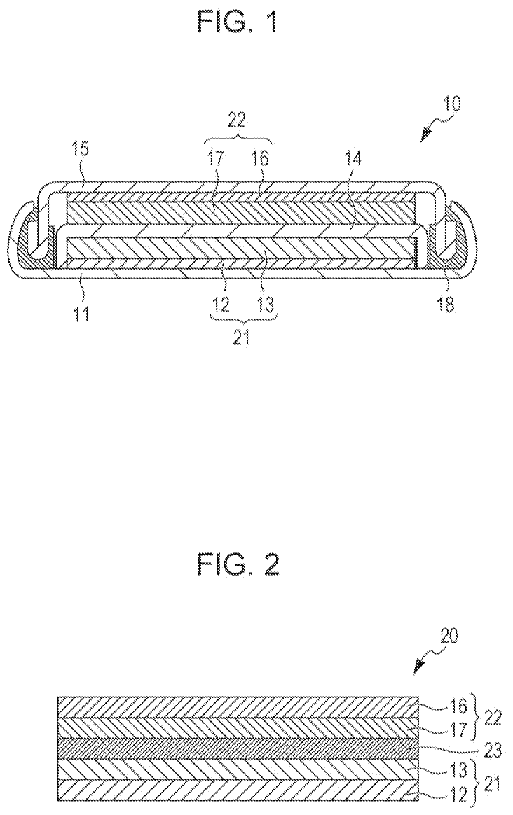

FIG. 1 is a schematic sectional view illustrating a configuration example of a battery 10 according to the present disclosure.

The battery 10 includes a positive electrode 21, a negative electrode 22, a separator 14, a case 11, a sealing plate 15, and a gasket 18. The separator 14 is disposed between the positive electrode 21 and the negative electrode 22. The positive electrode 21, the negative electrode 22, and the separator 14 are impregnated with an electrolyte and housed in the case 11. The case 11 is closed by using the gasket 18 and the sealing plate 15.

Examples of the structure of the battery 10 include a cylindrical type, a square type, a button type, a coin type, a laminate type, and a flat type.

The battery 10 is, for example, a lithium ion secondary battery. In such an instance, the negative electrode 22 includes a negative electrode layer capable of occluding and releasing lithium ions. In this regard, the electrolyte has lithium ion conductivity.

Examples of battery reactions in the lithium ion secondary battery are as described below. In this regard, x in the formulae represents the carbon atom number relative to one oxygen atom in the graphene oxide.

I. Discharge Reaction (During Battery Use)

negative electrode: Li→Li⁺+e⁻ (1)

positive electrode; Li⁺+e⁻+CₓO→LiCₓO (2)

II. Charge Reaction (During Battery Charging)

negative electrode; Li⁺+e⁻→Li (3)

positive electrode; LiCₓO→Li⁺+e⁻+CₓO (4)

During discharge, as illustrated in Formula (1) and Formula (2), an electron and a lithium ion are released from the negative electrode. In the positive electrode, an electron is taken up and a lithium ion is bonded to an oxygen that is bonded as graphene oxide. During charge, as illustrated in Formula (3) and Formula (4), an electron and a lithium ion are taken into the negative electrode. In the positive electrode, the bond between the electron and the oxygen is broken and an isolated lithium ion is released.

### 1-2. Positive Electrode

The positive electrode 21 includes a positive electrode collector 12 and a positive electrode layer 13 disposed on the positive electrode collector 12. The positive electrode layer 13 includes graphene oxide. The graphene oxide can function as an active material.

The graphene oxide is a material that may be formed through oxidization of graphene. The graphene oxide usually has a functional group including oxygen. Examples of the functional group including oxygen include a hydroxy group, a phenolic hydroxy group, a carboxy group, and an epoxy group. As is understood from Formulae (2) and (4) above, bonding of carrier ions such as lithium ions to the graphene oxide proceeds in accordance with discharge of the battery 10. In the present specification, the state in which carrier ions are bonded to the graphene oxide is also assumed to be graphene oxide in the same manner as the state before bonding.

The O/C ratio of the graphene oxide may be greater than or equal to 0.1 and less than or equal to 0.3.

The positive electrode layer 13 may contain a positive electrode active material other than the graphene oxide. For example, the positive electrode layer 13 of the lithium ion secondary battery may contain a known positive electrode active material used for a lithium ion secondary battery and the graphene oxide.

The positive electrode layer 13 of the battery 10 formed by using the manufacturing method according to the present disclosure may contain unoxidized carbon material. In this regard, the graphene oxide and the unoxidized carbon material can function as conductive materials.

The positive electrode layer 13 may be a porous layer containing graphene oxide. The positive electrode layer 13 may be a carbon material layer,

The positive electrode layer 13 may further contain a binder, as the situation demands.

Examples of the binder include polyvinylidene fluorides, polytetrafluoroethylenes, polyethylenes, polypropylenes, aramid resins, polyamides, polyimides, polyimide-imides, polyacrylonitriles, polyacrylic acids, polyacrylic acid methyl esters, polyacrylic acid ethyl esters, polyacrylic acid hexyl esters, polymethacrylic acids, polymethacrylic acid methyl esters, polymethacrylic acid ethyl esters, polymethacrylic acid hexyl esters, polyvinyl acetates, polyvinylpyrrolidones, polyethers, polyether sulfones, hexafluoropolypropylenes, styrene-butadiene rubber, and carboxymethyl cellulose. For example, the binder may be a copolymer of a plurality of types selected from the group consisting of tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene.

When the positive electrode layer 13 includes a binder, the content thereof is, for example, greater than or equal to 1% by weight and less than or equal to 40% by weight.

The positive electrode layer 13 may be formed as described below, for example. Initially, a positive electrode active material and a binder are kneaded. A mixer such as a ball mill may be used for kneading to obtain a positive electrode mix. The positive electrode mix is then rolled into a plate shape by using a rolling machine so as to form the positive electrode layer 13. Alternatively, a solvent is added to the resulting mixture so as to form a positive electrode mix paste, and the surface of the positive electrode collector 12 may be coated with the positive electrode mix paste. The positive electrode layer 13 is formed by drying the positive electrode mix paste. In this regard, the positive electrode layer 13 may be compressed to increase the electrode density.

The positive electrode layer 13 and the positive electrode 21 may be formed as described below. A precursor battery is assembled by using a positive electrode including a precursor layer containing a carbon material and an electrolyte which includes a Lewis acid containing a pentafluorophenyl group and in which oxygen is dissolved. The precursor battery is charged while the precursor layer is impregnated with the electrolyte so as to oxidize the carbon material and form the positive electrode 21 including the positive electrode layer 13 containing graphene oxide and the positive electrode 21 including the positive electrode layer 13. The carbon material usually includes a graphene structure. Examples of the carbon material include graphite, graphene, carbon nanotube, and carbon black. Examples of the carbon black include acetylene black and oil furnace black. The carbon material may contain graphene oxide, and the O/C ratio of the graphene oxide is increased by oxidation.

There is no particular limitation regarding the film thickness of the positive electrode layer 13. The film thickness may be greater than or equal to 2 μm and less than or equal to 500 μm and, further, may be greater than or equal to 5 μm and less than or equal to 300 μm.

The material for forming the positive electrode collector 12 is, for example, a metal, an alloy, or carbon. More specifically, the material for forming the positive electrode collector 12 may be a metal or an alloy containing at least one selected from the group consisting of stainless steel, nickel, aluminum, iron, and titanium. However, the material for forming the positive electrode collector 12 is not limited to the above-described examples.

The positive electrode collector 12 may have a tabular shape or a foil-like shape and may be porous, mesh-like, or nonporous. The positive electrode collector 12 may be a multilayer film.

The thickness of the positive electrode collector 12 may be greater than or equal to 10 μm and less than or equal to 1,000 μm and, further, may be greater than or equal to 20 μm and less than or equal to 400 μm.

When the case 11 also serves as a positive electrode collector, the positive electrode collector 12 is not limited to being disposed.

### 1-3. Negative Electrode

The negative electrode 22 includes a negative electrode layer 17 containing a negative electrode active material and a negative electrode collector 16.

The negative electrode layer 17 includes the negative electrode active material capable of occluding and releasing carrier ions. In the lithium ion secondary battery, carrier ions are lithium ions. Examples of the negative electrode active material capable of occluding and releasing lithium ions will be described below. However, the negative electrode active material is not limited to the examples described below.

The negative electrode active material is, for example, a substance containing elemental lithium. Specific examples of the negative electrode active material include lithium metal and lithium-containing alloys, oxides, and nitrides. Examples of the alloys include lithium aluminum alloys, lithium tin alloys, lithium lead alloys, and lithium silicon alloys. Examples of the oxides include lithium titanium oxides. Examples of the nitrides include lithium cobalt nitrides, lithium iron nitrides, and lithium manganese nitrides.

The negative electrode layer 17 may contain just one type of active material or may contain two or more types of active materials.

The negative electrode layer 17 may further contain a binder, as the situation demands. Regarding the binder, for example, the materials described in “1-2. Positive electrode” may be used. In this regard, when the negative electrode layer 17 has a foil-like shape, the negative electrode layer 17 may contain just the negative electrode active material.

When the negative electrode layer 17 includes a binder, the content is, for example, greater than or equal to 1% by weight and less than or equal to 40% by weight.

The material for forming the negative electrode collector 16 is, for example, a metal, an alloy, or carbon. More specifically, the material for forming the negative electrode collector 16 may be a metal or an alloy containing at least one selected from the group consisting of copper, stainless steel, and nickel. However, the material for forming the negative electrode collector 16 is not limited to the above-described examples.

The negative electrode collector 16 may have a tabular shape or a foil-like shape and may be porous, mesh-like, or nonporous. The negative electrode collector 16 may be a multilayer film.

When the case 11 also serves as a negative electrode collector, the negative electrode collector 16 is not limited to being disposed.

The negative electrode 22 may be formed by using a known technique.

### 1-4. Separator

Examples of the separator 14 include a porous film, a woven fabric, and a nonwoven fabric. Examples of the nonwoven fabric include resin nonwoven fabrics, glass fiber nonwoven fabrics, and paper nonwoven fabrics. Examples of the material for forming the separator 14 include polyolefins such as polypropylenes and polyethylenes. The thickness of the separator 14 is, for example, greater than or equal to 10 μm and less than or equal to 300 μm. The separator 14 may be a single-layer film composed of one type of material or may be a composite film or a multilayer film composed of two or more types. The porosity of the separator 14 is, for example, within the range of greater than or equal to 30% and less than or equal to 90% or may be within the range of greater than or equal to 35% and less than or equal to 60%.

### 1-5. Electrolyte

The electrolyte is a material having carrier ion conductivity. The electrolyte of the lithium ion secondary battery is a material having lithium ion conductivity. The electrolyte of the lithium ion secondary battery will be described below.

The electrolyte is, for example, an electrolyte solution. The electrolyte solution includes, for example, a solvent and a lithium salt dissolved in the solvent. Usually, the solvent is a nonaqueous solvent.

Examples of the nonaqueous solvent include alcohols, ethers, carbonic acid esters, and carboxylic acid esters. The ethers, carbonic acid esters, and carboxylic acid esters may each have a circular or chain-like shape.

Examples of the alcohol include ethanol, ethylene glycol, and propylene glycol.

Examples of the cyclic ether include 4-methyl-1,3-dioxolane, 2-methyltetrahydrofuran, and crown ethers, Examples of the chain ether include 1,2-dimethoxyethane, ethylene glycol dimethyl ether, diethylene glycol dimethyl ether, triethylene glycol dimethyl ether, and tetraethylene glycol dimethyl ether. Examples of the cyclic carbonic acid ester include ethylene carbonate, propylene carbonate, butylene carbonate, fluoroethylene carbonate, and 4,5-difluoroethylene carbonate. Examples of the chain carbonic acid ester include dimethyl carbonate, ethyl methyl carbonate, and diethyl carbonate. Examples of the cyclic carboxylic acid ester include γ-butyrolactone. Examples of the chain carboxylic acid ester include ethyl acetate, propyl acetate, and butyl acetate.

The electrolyte may contain just one type of solvent or may contain two or more types of solvents.

Examples of the lithium salt include lithium perchlorate (LiClO₄), lithium hexafluorophosphate (LiPF₆), lithium tetrafluoroborate (LiBF₄), lithium trifluoromethanesulfonate (LiCF₃SO₃), and lithium bis(trifluoromethanesulfonyl)amide (LiN(CF₃SO₂)₂). The lithium salt may be LiBF₄. However, the lithium salt is not limited to the above-described examples.

The electrolyte may contain just one type of lithium salt or may contain two or more types of lithium salts.

The amount of the lithium salt dissolved in the electrolyte solution is, for example, greater than or equal to 0.5 mol/L and less than or equal to 2.5 mol/L.

The electrolyte includes a Lewis acid containing a pentafluorophenyl group. Examples of the Lewis acid include tetrakis(pentafluorophenyl)borate. The Lewis acid containing a pentafluorophenyl group has strong oxidizing power and, in addition, usually dissolves oxygen sufficient for setting the O/C ratio of graphene oxide to be greater than or equal to 0.1.

The concentration of the Lewis acid in the electrolyte may be greater than or equal to 6% by weight and, further, may be greater than or equal to 16% by weight. The upper limit of the concentration is, for example, less than or equal to 50% by weight.

### 1-6. Others

The case 11 may be provided with a gas feed tube and/or a gas discharge tube. Examples of the gas include oxygen-containing gas and inert gas. Examples of the oxygen-containing gas include oxygen gas. Examples of the inert gas include argon gas. The oxygen-containing gas is used for, for example, dissolving oxygen in the electrolyte. The inert gas is used for, for example, purging excess oxygen-containing gas to outside the case 11 when the gas remains in the case 11 after oxygen is dissolved in the electrolyte. The gas may be dry air.

### 1-7. Modified Example

FIG. 2 is a schematic sectional view illustrating a configuration example of a battery 20.

The battery 20 includes a positive electrode 21, a negative electrode 22, and a solid electrolyte 23. The positive electrode 21, the solid electrolyte 23, and the negative electrode 22 are stacked in this order so as to form a multilayer body.

The positive electrode 21 is, for example, the same as the positive electrode described in “1-2. Positive electrode” above. The negative electrode 22 is, for example, the same as the negative electrode described in “1-3. Negative electrode” above. The solid electrolyte 23 has carrier ion conductivity and includes a Lewis acid containing a pentafluorophenyl group.

### 2. Method for Manufacturing Battery

The manufacturing method according to the present disclosure includes a first step of dissolving oxygen in an electrolyte including a Lewis acid containing a pentafluorophenyl group. The first step may be performed by, for example, passing oxygen-containing gas through an electrolyte. At this time, the electrolyte may be an electrolyte solution. Examples of the oxygen-containing gas are as described in “1-6. Others” above, However, the method for dissolving oxygen in the electrolyte is not limited to the above-described example.

The manufacturing method according to the present disclosure includes a second step of charging a precursor battery including a positive electrode, a negative electrode, and the electrolyte which is located between the positive electrode and the negative electrode and in which oxygen is dissolved. The second step is performed after the first step. The positive electrode of the precursor battery includes a precursor layer containing a carbon material and the electrolyte. In the precursor layer, the carbon material and the electrolyte are in the state of being in contact with each other. A porous body composed of the carbon material may be in the state of being impregnated with the electrolyte. The electrolyte includes a Lewis acid containing a pentafluorophenyl group. The carbon material is oxidized due to charging, and the precursor layer is converted to the positive electrode layer 13. The precursor battery is converted to the battery according to the present disclosure.

Usually, the carbon material contained in the precursor layer includes a graphene structure. Examples of the carbon material are as described in “1-2. Positive electrode” above. The carbon material may contain graphene oxide, and the O/C ratio of the graphene oxide is increased due to charging.

In the second step, charging may be performed while the potential of the positive electrode relative to a Li/Li⁺ reference electrode is set to be greater than or equal to 4.3 V. In such an instance, the charging is not limited to being performed throughout the interval from start to stop of the charging, and the charging may be performed in at least part of the interval.

As the situation demands, the manufacturing method according to the present disclosure may include a third step of purging gas that includes oxygen and that remains inside the battery formed in the second step to the outside. Purge may be performed by, for example, introducing inert gas into the battery. Inert gas may be passed through the electrolyte. At this time, the electrolyte may be an electrolyte solution. Performing the third step enables, for example, the stability of the resulting battery to be improved. Examples of the inert gas are as described in “1-6. Others” above.

### EXAMPLES

The present disclosure will be described below in further detail with reference to the examples. The following examples are exemplifications, and the present disclosure is not limited to the following examples.

### Sample 1

### Comparative Example

A powder of graphene oxide (Graphene oxide produced by NIPPON SHOKUBAI CO., LTD.) was prepared as a positive electrode active material. A molding powder of polytetrafluoroethylene (POLYFLON F-104 produced by Daikin Industries, Ltd.) was prepared as a binder. The graphene oxide and the binder were mixed and kneaded so that the weight ratio of the graphene oxide to the binder was set to be 7:3. The resulting mixture was rolled by using a pressing machine so as to obtain a positive electrode layer. A porous aluminum sheet (Aluminum-Celmet produced by Sumitomo Electric Industries, Ltd.) was prepared as a positive electrode collector. The positive electrode layer was placed on the positive electrode collector and set in a pressing machine. The positive electrode layer and the positive electrode collector were press-bonded by performing pressing so as to produce a positive electrode including the positive electrode layer containing graphene oxide. A lithium sheet having a thickness of 300 μm was prepared as a negative electrode. A propylene carbonate (produced by KISHIDA CHEMICAL Co., Ltd; hereafter referred to as “PC”) solution of LiBF₄ (produced by KISHIDA CHEMICAL Co., Ltd.) was prepared as a nonaqueous electrolyte solution. The LiBF₄ concentration of the nonaqueous electrolyte solution was set to be 1 mol/L. The nonaqueous electrolyte solution was obtained by mixing LiBF₄ into PC and performing agitation for a night in an atmosphere of dry air having a dew point of lower than or equal to −50° C. so as to dissolve LiBF₄ in PC. A glass fiber separator was prepared as a separator. A secondary battery illustrated in FIG. 1 was produced by using the positive electrode, the negative electrode, the separator, and the nonaqueous electrolyte solution. During production of the secondary battery. Processes (1) to (3) below were performed.

(1) A multilayer body composed of the positive electrode, the separator, and the negative electrode was assembled. Thereafter, these were impregnated with the nonaqueous electrolyte solution so as to obtain a precursor battery. After oxygen was dissolved in the nonaqueous electrolyte solution by passing through oxygen gas, an open-circuit voltage between the positive electrode and the negative electrode was measured. The oxygen concentration of the oxygen gas passed through was set to be 99.999% by volume, and the gas passing time was set to be 30 minutes.

(2) The precursor battery was charged. The charge voltage was started from the measured open-circuit voltage, increased at a constant rate, and set to be constant after 4.3 V was reached. Since the negative electrode of the precursor battery was composed of lithium, from the point in time when the charge voltage was set to be constant, charge was performed while the potential of the positive electrode relative to a Li/Li⁺ reference electrode was set to be +4.3 V. The charge of the precursor battery was completed at the time when the potential of the positive electrode relative to the negative electrode reached +4.3 V.

(3) Oxygen gas remaining inside the battery was removed by passing argon gas through the nonaqueous electrolyte solution. The battery was hermetically sealed so as to obtain a secondary battery of Sample 1.

Regarding Sample 1, the O/C ratio of graphene oxide contained in the positive electrode layer was evaluated. The result was 0.2.

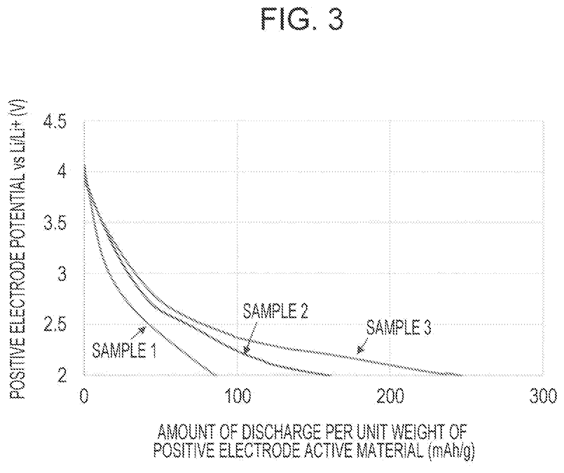

Regarding Sample 1, a discharge test was performed. The discharge test was performed so that the secondary battery was discharged at a constant current of 0.1 mA/cm² until the potential of the positive electrode relative to the negative electrode reached +2.0 V. FIG. 3 and Table 1 illustrate the result of the discharge test. In this regard, Voltage V1 in Table 1 represents the voltage of the battery when the amount of discharge per unit weight of the positive electrode active material reached 30 mAh/g.

### Sample 2

A secondary battery of Sample 2 was obtained in the same manner as Sample 1 except that a nonaqueous electrolyte solution in which tetrakis(pentafluorophenyl)borate (produced by TOKYO KASEI KOGYO CO. LTD; hereafter referred to as “TPFPB”) was further dissolved at a concentration of 6% by weight was used. FIG. 3 and Table 1 illustrate the result of the discharge test of Sample 2. In this regard, the O/C ratio of graphene oxide contained in the positive electrode layer of Sample 2 was 0.2.

### Sample 3

A secondary battery of Sample 3 was obtained in the same manner as Sample 1 except that a nonaqueous electrolyte solution in which TPFPB was further dissolved at a concentration of 16% by weight was used. FIG. 3 and Table 1 illustrate the result of the discharge test of Sample 3. In this regard, the O/C ratio of graphene oxide contained in the positive electrode layer of Sample 3 was 0.2.

TABLE 1

| | Concentration of | Amount of discharge | |
|---|---|---|---|
| | TPFPB in nonaqueous | per unit weight of | Voltage |
| | electrolyte solution | positive electrode active | V1 |
| | (% by weight) | material (mAh/g) | (V) |
| Sample 1 | 0 | 85 | 2.62 |
| (comparative | | | |
| example) | | | |
| Sample 2 | 6 | 164 | 2.92 |
| Sample 3 | 16 | 247 | 3.09 |

As illustrated in FIG. 3 and Table 1 Samples 2 and 3 had a greater capacity than Sample 1.

The battery according to the present disclosure is useful for, for example, a lithium ion secondary battery.

What is claimed is:

1. A battery comprising:
a positive electrode;
a negative electrode; and
an electrolyte located between the positive electrode and the negative electrode,
wherein the positive electrode includes a positive electrode layer containing graphene oxide, and
the electrolyte includes a Lewis acid containing a pentafluorophenyl group.

2. The battery according to claim 1,
wherein the weight ratio of oxygen to carbon in the graphene oxide is greater than or equal to 0.1 and less than or equal to 0.3.

3. The battery according to claim 1,
wherein the Lewis acid is tetrakis(pentafluorophenyl)borate.

4. The battery according to claim 1,
wherein the concentration of the Lewis acid in the electrolyte is greater than or equal to 6% by weight.

5. The battery according to claim 1,
wherein the concentration of the Lewis acid in the electrolyte is greater than or equal to 16% by weight.

6. The battery according to claim 1,
wherein the negative electrode includes a negative electrode layer capable of occluding and releasing lithium ions.

7. The battery according to claim 6,
wherein the negative electrode layer includes an active material containing a lithium element.

8. The battery according to claim 6,
wherein the negative electrode layer includes lithium metal as an active material.

9. The battery according to claim 1,
wherein the electrolyte is an electrolyte solution containing a nonaqueous solvent and a lithium salt dissolved in the nonaqueous solvent.

10. The battery according to claim 9,
wherein the nonaqueous solvent is a carbonic acid ester.

11. The battery according to claim 9,
wherein the lithium salt is lithium tetrafluoroborate (LiBF₄).

12. A method for manufacturing a battery according to claim 1 comprising:
dissolving oxygen in an electrolyte including a Lewis acid containing a pentafluorophenyl group; and
charging a precursor battery including a positive electrode, a negative electrode, and the electrolyte in which oxygen is dissolved, the electrolyte being located between the positive electrode and the negative electrode,
wherein the positive electrode in the precursor battery includes a precursor layer containing a carbon material and the electrolyte.

13. The method for manufacturing a battery according to claim 12,
wherein in the charging of a precursor battery, the precursor battery is charged while the potential of the positive electrode relative to a Li/Li⁺ reference electrode is set to be greater than or equal to 4.3 V.
